(19) United States
(12) Patent Application Publication
(10) Pub. No.: US 2020/0175107 A1
(43) Pub. Date: Jun. 4, 2020

(54) method and system for passion identification of a user

(71) Applicant: MeVero Inc., Palo Alto, CA (US)

(72) Inventors: Kaushik Banerjee, Kolkata (IN); Dipankar Ganguly, Kolkata (IN); Arnab Dhar, Kolkata (IN); Arnab Pan, Kolkata (IN); Aritra Sarkar, Kolkata (IN)

(21) Appl. No.: 16/673,505

(22) Filed: Nov. 4, 2019

Related U.S. Application Data
(60) Provisional application No. 62/773,207, filed on Nov. 30, 2018.

(51) Int. Cl. G06F 17/27; G06F 16/335; G06N 3/02; G06F 16/332; H04L 12/58; G06F 16/35

(52) U.S. Cl. CPC G06F 17/2765; G06F 16/337; G06F 16/353; G06F 16/3326; H04L 51/02; G06N 3/02

(57) ABSTRACT

The proposed invention helps a person to identify his/her passion using an automated online conversational system (hereinafter “bot”). The bot engages with the person via a conversation and based on the responses from the person helps the person in identifying his/her passion. The entire conversation is text based so as to allow the user more flexibility in expressing himself/herself. The answers of the user are analyzed by the bot using natural language processing techniques to fire a series of questions with the ultimate aim of identification of passion. The sequence in which questions are fired are rule driven based on the responses of the user. The user communication with the bot is via a user interface across three different devices viz—web, Android™ and iOS™.

### CROSS REFERENCE TO RELATED APPLICATIONS

This application claims priority to U.S. Provisional Patent Application No. 62/773,207 filed on Nov. 30, 2018 entitled “Artificial Intelligence Life Coach Chatbot,” the contents of which are hereby incorporated by reference in their entirety.

### FIELD

The present invention relates to a method and system related to an automated online conversational system. More specifically it relates to the discovery of the passion of a user via an automated online conversational system.

### BACKGROUND

It is a common phenomenon worldwide that people in general are unable to follow their passion. They face barriers in the form of lack of adequate resources, peer help, a bias free environment and other factors which leads to dissatisfaction of the individual. Even worse, is the fact that some people are not even aware of their passion. Very few people have the opportunity to follow his/her passion and lead a satisfied life. It would therefore be very useful if individuals could be aided in the identification of their passion.

User passion can be varied and across a plethora of domains. Therefore identification of the passion of any individual especially when the person is unaware of it is an uphill task. Passions may vary and depend on the basic nature of an individual, his current work environment, his geographical location, etc. The passion universe is not exhaustive and its vastness needs to be emphasized. Also, a person's passion may change over time just as priorities in life change. However, if by any means the passion of a person can be identified or a person can be aided to find his/her passion, then the pursuit of it becomes easier and the person becomes satisfied in life.

Usually seeking personal advice from an expert to explore one's own passion is time consuming and expensive. It also requires a user to divulge sensitive information about his/her life to a person and thus a user may hesitate to share such information to an unknown person i.e. the expert. Therefore, there is an unresolved and unfulfilled need for a method and system for discovering the passion of a user using an automated online conversational system.

### SUMMARY

The present invention connects to a method and system related to an automated online conversational system. More specifically it relates to the discovery of the passion of a user via an automated online conversational system.

The method for identifying a passion of a user, comprising

sequentially transmitting a first set of queries to a user wherein said first set of queries comprises an odd number of predetermined plural queries, and wherein each query has two possible answers;

receiving a response comprising textual input from a user for each of said first set of queries, wherein said textual input is classified by an intent classifier to fall into one of said two possible answers;

tallying said responses to each query to determine four basic behavior characteristics of said user;

looking up a table to determine the trait of the user based on said identified four basic behavior characteristics of the said user;

sequentially transmitting a second set of queries to a user wherein said second set of queries comprises a plurality of predetermined queries based on said identified trait of said user;

receiving a response comprising textual input from said user for each of said second set of queries;

classifying said responses by said intent classifier to obtain the passion of said user.

In an embodiment, the classification by the intent classifier comprises:

cleaning said received responses using auto spell check and auto correction;

breaking down said cleaned responses into words;

classifying said words to obtain an intent of the user from said responses, wherein classification of said words is carried out by said intent classifier comprising a neural network model trained with a mapping of words to intent.

Further, classification by said intent classifier comprises determining a similarity score between words in said responses with predetermined model answers of each query to determine intent of said user, wherein a classification confidence is provided by the intent classifier.

If the similarity score for a response to a query is below a predetermined threshold value, the query is re-transmitted to the user for a rephrased response.

The system for identifying a passion of a user, comprising at least a processor, a memory and a transceiver, said processor operably coupled to said memory and said transceiver, said memory comprising computer readable instructions to configure the processor for:

sequentially transmitting a first set of queries to a user wherein said first set of queries comprises an odd number of predetermined plural queries, and wherein each query has two possible answers;

receiving a response comprising textual input from a user for each of said first set of queries, wherein said textual input is classified by an intent classifier to fall into one of said two possible answers;

tallying said responses to each query to determine four basic behavior characteristics of said user;

looking up a table to determine the trait of the user based on said identified four basic behavior characteristics of said user;

sequentially transmitting a second set of queries to a user wherein said second set of queries comprises a plurality of predetermined queries based on said identified trait of said user;

receiving a response comprising textual input from said user for each of said second set of queries; and

classifying said responses by said intent classifier to obtain the passion of said user.

The classification by the intent classifier comprises:

cleaning said received responses using auto spell check and auto correction;

breaking down said cleaned responses into words;

classifying said words to obtain an intent of the user from said responses, wherein classification of said words is carried out by said intent classifier comprising a neural network model trained with a mapping of words to intents.

The classification by said intent classifier further comprises determining a similarity score between words in said responses predetermined model answers of each query to determine intent of said user, wherein a classification confidence provided by the intent classifier for each response. In case, said similarity score for a response to a query is below a second predetermined threshold value, the query is re-transmitted to the user for a rephrased response.

### BRIEF DESCRIPTION OF THE DRAWINGS

The invention will be more clearly understood from the following description of an embodiment thereof, given by way of example only, with reference to the accompanying drawings, in which:

FIG. 1 exemplarily illustrates a flowchart of the passion identification method in accordance with some of the embodiments of the present invention;

FIG. 2 exemplarily illustrates a block diagram of a passion identification system comprising an automated conversational system in accordance with some of the embodiments of the present invention; and

FIG. 2A illustrates a functional block diagram of an automated conversational system in accordance with some of the embodiments of the present invention.

### DETAILED DESCRIPTION OF THE DRAWINGS

The present invention relates to a method and system related to an automated online conversational system. More specifically it relates to the discovery of passion of a user via an automated online conversational system.

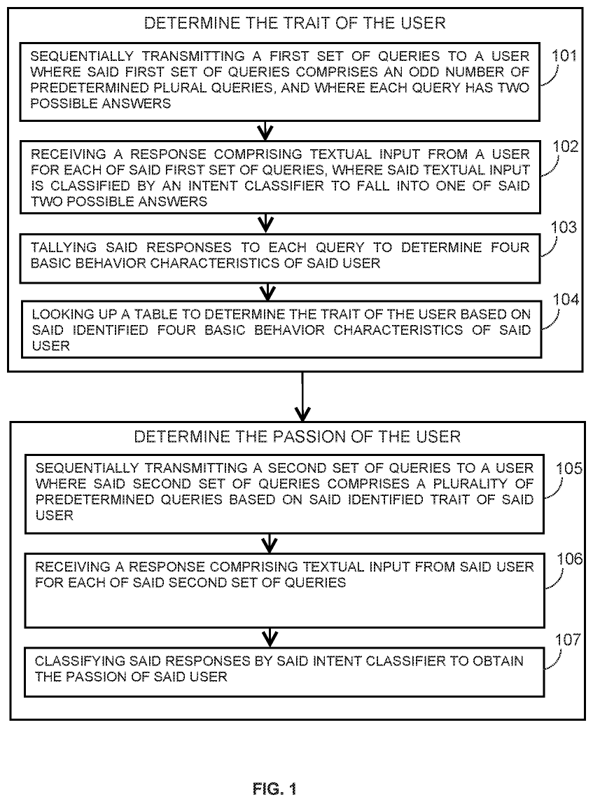

FIG. 1 exemplarily illustrates a flowchart of the passion identification method in accordance with some of the embodiments of the present invention. The present invention relates to a method and system related to an automated online conversational system. More specifically it relates to the discovery of passion of a user via an automated online conversational system.

The method for identifying a passion of a user comprises the following steps of identifying a trait of the user and subsequently determining the passion based on the determined trait of the user. A first set of queries is sequentially transmitted 101 to a user device wherein said first set of queries comprises an odd number of predetermined plural queries, and wherein each query has two possible answers. The user enters a textual response to each of the transmitted query and accordingly a processor receives 102 a response comprising textual input from said user for each of said first set of queries. Each of the textual response to queries is classified by an intent classifier to fall into one of said two possible answers. In other words a response comprising textual input from a user for each of said first set of queries is received, wherein said textual input is classified by an intent classifier to fall into one of said two possible answers.

Said responses to each query is tallied 103 to determine four basic behavior characteristics of said user and the responses to each query determines four basic behavior characteristics of said user. Further, a table is looked up 104 to determine the trait of the user based on said four basic behavior characteristics of said user.

In an embodiment, the user trait universe has been segmented so as to be the union of 4 broad behavioral classes. This has been done using psychological techniques and methods. The four classes into which the trait universe is segmented are as follows.

Class A—Extroverts versus Introverts

Class B—Open versus Traditional

Class C—Conscientious versus Disorganized

Class D—Agreeable versus Rebellious

Some of the distinguishing features of each of the above mentioned classes are given in the following four tables below. They are not exhaustive.

In other words questions are posed to the user, where the tally scores of answers to such questions may be classified as extravert vs. introvert and/or open vs. traditional etc.

TABLE 1
Class A

| EXTROVERT | INTROVERT |
|---|---|
| Highly active, energetic, enthusiastic | Passive by nature and at times |
| | inactive |
| Expressive | Cool, reserved and retiring |
| Sociable | Private and unsociable |
| Impulsive | Have limited intimate friends |
| Assertive | Non spontaneous |
| Talkative | Good listener |
| Bold and dominant | Sober |
| Outgoing, carefree, fun loving | Cautious, careful and alert to |
| | situations |
| Does not like to stay alone | Like to plan ahead |
| Excitement seeking and sensation seeking | Introspective |
| Optimistic and risk taker | Observant and calculative |
| Possess leadership qualities | Focus on details |
| and hence prefer public roles | |
| Aggressive and short tempered | Attentive and mindful |
| | Recessive and humble |
| | Private about emotions |
| | Averse to excitement |
| | Not adventurous |
| | Pessimistic |

TABLE 2
Class B:

| OPEN | TRADITIONAL |
|---|---|
| Creative in nature | Admire practical solutions |
| Focus on possibilities | Good observer and has focus on |
| | details |
| Have an eye for novelty | Pragmatic in approach |
| Prefer variety | Trust actual experiences |
| Appreciate originality | Prefer to use established skills |
| Imaginative | Focus on current situation |
| Inventive | Follows step by step instructions |
| Liberal | Work at a steady pace |
| Curious | |
| Trust instincts | |
| Keen to learn and use new | |
| skills | |
| Like to figure out things | |
| themselves | |
| Energetic | |
| Like to work on flexible plan | |

TABLE 3
Class C

| CONSCIENTIOUS | DISORGANIZED |
|---|---|
| Conscientious in approach | Casual in their approach |
| Hard working | Not punctual |
| Ambitious | Lenient |
| Well organized | Job at hand is secondary |
| Punctual | Do not like to follow rules |
| Persevering | Disorganized in approach to |
| | tasks |
| Trust people | Likes to keep plans flexible |
| Take responsibilities seriously | Face difficulty in decision |
| | making |
| Usually prompt | Want more freedom and |
| | spontaneity |
| Current work is treated with utmost | |
| importance | |
| Like to make plans and follow it strictly | |
| Prefers to finish projects on time | |
| Appreciate the need for rules | |

TABLE 4
Class D:

| AGREEABLE | REBELLIOUS |
|---|---|
| Soft hearted | Honest and direct |
| Trustworthy | Make decisions objectively |
| Generous | Cool and reserved |
| Acquiescent | Convinced by rational |
| | arguments |
| Lenient | Value honesty and fairness |
| Good natured | Good at pointing out flaws |
| Decision based on values and | Motivated by achievement |
| feelings | |
| Appear warm and friendly | Likes to argue and debate |
| Diplomatic and tactful | |
| Value harmony and compassion | |
| Quick to compliment | |
| Avoid arguments and conflicts | |
| Motivated by appreciation | |

In other words, an odd number of questions against each class described above have been framed. These questions are fired to the user sequentially. Based on the responses of the user, he/she is classified into one each of extrovert or introvert, open or traditional, conscientious or disorganized, agreeable or rebellious. An odd number of questions are asked so that classification of a user to a class becomes easier. So in effect a user belongs to one of the following 16 classes as listed below.
EOAC—Extrovert, Open, Agreeable, Conscientious
EORC—Extrovert, Open, Rebellious, Conscientious
EOAU—Extrovert, Open, Agreeable, Uncritical
EORU—Extrovert, Open, Rebellious, Uncritical
ETAC—Extrovert, Traditional, Agreeable, Conscientious
ETRC—Extrovert, Traditional, Rebellious, Conscientious
IOAC—Introvert, Open, Agreeable, Conscientious
ITAC—Introvert, Traditional, Agreeable, Conscientious
ITRC—Introvert, Open, Agreeable, Conscientious 42
ETAU—Extrovert, Traditional, Agreeable, Uncritical
ETRU—Extrovert, Traditional, Agreeable, Uncritical
IOAU—Introvert, Open, Agreeable, Uncritical
IORC—Introvert, Open, Agreeable, Uncritical
IORU—Introvert, Open, Rebellious, Uncritical
ITAU—Introvert, Traditional, Agreeable, Uncritical
ITRU—Introvert, Traditional, Rebellious, Uncritical

Further, the above group of characteristics of a user is used to identify the trait in accordance with the following:

Of the above 16 classes, distinguishing features described below have been used to cluster them into 5 distinct trait categories. This categorization has been made based on psychological techniques.

For users who belong to either of EOAC, EORC, EOAU, EORU—These users are outgoing and natural leaders and can be seen as pro people person. These kinds of persons possess excellent leadership qualities and have the ability to make people do what they want them to do. They are straight forward, honest and decisive individuals. They can be classified as leadership oriented.

For users who belong to either of ETAC, ETRC, IOAC, ITAC, ITRC—These users value relationships and commitment. They are responsible, duty oriented and dependable. They encourage others. They are highly protective and genuinely warm towards loved ones. They are faithful and loyal. They are sensitive, intuitive, independent, conforming and possess a keen understanding of others' point of view and hence tend to put others' needs above their own. They have an internal sense of duty. They can be classified as responsibility oriented.

For users who belong to either of ETAU, ETRU—These users are attention seekers and are action oriented.

They enjoy being the center of attention. They are very observant, fun loving and are spontaneous risk takers. They have a well-developed sense for aesthetic beauty and flair for drama. They are action oriented.

For those who belong to either of IOAU, IORC or IORU—They are insightful, logical and knowledge oriented. They see everything in terms of how it could be improved or what it could be turned into. They value knowledge and intelligence. They are extremely bright, and have an analytical mind, and are keen to find solutions. They do not pay importance to the external world. They are knowledge oriented.

For those who belong to either of ITAU, ITRU—They are task oriented, and give importance to hands-on concrete experience. They are unusually gifted at creating and composing and will rebel against anything conflicting with their goals. They possess strong affinity towards aesthetics and beauty and sense of adventure. They judge everyone by their capability to perform tasks. They are task oriented.

A person skilled in the art would appreciate that the above relationship may be stored as a table, and the same may be looked up to determine the trait of the user based on said identified four basic behavior characteristics of said user.

The above has been provided by the way of an example and may not be construed to be limiting.

Based on said identified trait class or trait of a user a second set of queries to a user is sequentially transmitted 105. In other words said second set of queries comprises a plurality of predetermined queries based on said identified trait of said user i.e. for each trait class there is a set of predefined questions to query the user for obtaining the passion of the user.

The responses of each the above (passion identification) queries are received 106 where each response comprising textual input from said user for each of said second set of queries.

The responses are classified 107 by said intent classifier to obtain the passion of said user. In an embodiment, the classification by the intent classifier comprises cleaning said received responses using auto spell check and auto correction and breaking down said cleaned responses into words. Further, classifying said words to obtain an intent of the user from said responses, wherein classification of said words is carried out by said intent classifier comprising a neural network model trained with a mapping of words to intents. The intent classifier provides a classification confidence score along with the passion classification.

If such classification confidence score provided by the neural network is less than a threshold then said intent classifier determines a similarity score between words in said responses and predetermined model answers of each query

If the similarity score for a response to a query is below a second predetermined threshold value, the query is re-transmitted to the user for a rephrased response.

In an embodiment the intent classifier extracts the relevant information from the responses by following the below steps.

Preprocessing:

In this step, LSH (locality sensitive hashing) index is constructed for spell correction. LSH aims to put similar items into the same buckets with high probability. LSH hashing follows the following steps.

Shingling: In this step, each sentence is converted into a set of characters of length k. The key idea is to represent each sentence as a set of k-shingles. Similarity between sentences is measured using Jaccard similarity. The Jaccard similarity between sentences A & B is defined as

$$J ( A , B ) = \frac{\vert A ⋂ B \vert}{\vert A ⋃ B \vert} J ( A , B ) = \frac{\vert A ⋂ B \vert}{\vert A ⋃ B \vert}$$

In terms of scalability, Jaccard similarity has two 2 constraints, time and space complexity. To resolve this issue, Minhash technique has been used.

Datasketch python library has been used to build LSH index and glove vocabulary as corpus.

As a second step, a negative sentiment and user query understanding statistical model has been built. Negative sentiment understanding indicates whether the text entered by user is of positive or negative opinion, user query understanding here refers to what users have meant by the entered text i.e. whether the entered text is question or request or complaint etc. NLTK corpus has been used as dataset for sentiment understanding and NaiveBayesClassifier has been used to build the model.

Intent classification model: To identify the intent Google Dialogflow™ framework has been used. In Dialogflow, the basic flow of conversation involves the following steps:

On receiving the input

Dialogflow agent parses the input

The agent returns a response to the user

Dialogflow has been trained to build intent classification model using a predetermined annotated dataset D of the form (X,Y) where X is relevant keyword/key phrase and Y is the intent.

Keyword/key phrase extraction from user input:

Spell checking of user input: This module takes user text as input and splits the input into tokens. Each token is considered in lowercase from a token list and compared with NLP toolkit Wordnet™ whether it is correctly spelled. If it is not correctly spelled, then this token is passed to internal proprietary spell correction module.

Spell correction of user input: This module takes misspelled word as input and returns the corrected tokens. The misspelled word is passed to LSH index and the top n similar words are fetched. In the current disclosure, n has a value of 10. Levenshtein distance has been used to find out best match from top n similar words of misspelled word.

The Levenshtein distance between two strings a, b (of length |a| and |b| respectively) is given by lev_{a,b}(|a|, |b|) where

$$\underline{{lev}_{a , b }} ( \underline{i , j} ) = \{ \begin{matrix}max ( \underline{i , j} ) & if min ( i , j ) = 0 \\ min \{ \begin{matrix}{lev}_{\underline{a , b}} ( i - 1 , j ) + 1 \\ {lev}_{\underline{a , b}} ( i , j - 1 ) + 1 \\ {lev}_{\underline{a , b}} ( i - 1 , j - 1 ) + {1}_{( {a}_{j} \neq {b}_{j} )}\end{matrix} & otherwise\end{matrix}$$

where 1₍ₐ_{ⱼ}≠bⱼ₎ is the indicator function equal to 0 when aj=bj and equal to 1, otherwise, lev_{a,b}(i, j) is the distance between the first i characters of a and first j characters of b.

Identification of the user intent:

In this step, bot checks whether user response is relevant or there has been a major digression using negative sentiment and user query understanding model. If the user text is a relevant answer, bot fires the next question.

In the current disclosure, to identify a user passion, the following techniques have been used. Once done, the user passion is stored in the database.

Preprocessing:

The following tasks have been performed in preprocessing.

Dataset creation:

A corpus of different passion, profession, hobbies etc. has been created manually and on an incremental basis.

Clustering passion dataset:

The goal of clustering is to group the tokens into disjoint clusters, based on similarity between tokens, so that tokens in the same cluster are highly correlated to each other. For clustering the passion dataset, an undirected labelled graph data structure has been used. This can be represented as G=(V, E) where V is the set of passion tokens and E is the set of edges between two vertices if it satisfies the following condition.

The similarity score between two vertices is calculated using Word2vec pre-trained model and if the similarity score is above the certain threshold value, then the label of the edge is established as the edge between vertices with score.

After forming the similarity graph, HCS (Highly Connected Subgraph) clustering algorithm is used to find out the subgraphs with n vertices such that the minimum cut of those subgraphs contain more than n/2 edges, and said subgraphs are indicated as clusters.

Single vertices are not considered clusters and are grouped into a singleton set S.

Given a similarity graph G=(V, E), HCS the clustering algorithm checks if it is already highly connected. If so returns G, otherwise uses the minimum cut of G to partition G into two subgraphs H and H′, and further HCS clustering algorithm is recursively run on H and H′.

Cluster names are manually assigned which represent the parent of the cluster values to form ontology structure of passion dataset.

Relevant passion key phrase extraction:

Keyword/key phrase is extracted from user input to get n-grams of tokens.

Key phrase validation:

This module finds out the relevant key phrase from the list of n-gram tokens. A list of key phrases are kept those are satisfied by the validation module. For this purpose, an ontology-based passion dataset is used to check whether the key phrase exists or not. If any higher order n-grams satisfy the validation condition, then the lower order n-gram is discarded. If no key phrases are found then the user is requested to rephrase the response.

Finally, all the passion key phrases entered by user are collected to find out the repetition of a phrase. If found, then the bot identifies the passion of the user.

Otherwise each passion key phrase entered by user is expanded to form expanded passion list by using a Word2vec pre-trained model. In an embodiment top 3 similar tokens of each key phrases consider for an expanded list. From this expanded passion list, the clusters of similar tokens is formed by using graph-based clustering.

Each cluster contains similar tokens with its similarity score. The average score (sum of all score/number of tokens) of each cluster is calculated and the top cluster which has maximum average score is selected. In an embodiment top 3 tokens from the top cluster is selected.

In the current disclosure, for trait identification, below mentioned process has been followed.

Key phrase validation:

For checking whether key phrase exists, a predetermined corpus, pretrained glove word vector model and Dbpedia have been used. If any higher order n-grams satisfy the validation condition, then the lower order n-grams are discarded.

Corpus: The predetermined corpus consists of 3000 keywords/key phrases.

GloVe is an unsupervised learning algorithm for obtaining vector representations for words. Training is performed on aggregated global word-word co-occurrence statistics from a corpus, and the resulting representations showcase interesting linear substructures of the word vector space.

DBpedia is a project aiming to extract structured content from the information created in the Wikipedia project. This structured information is made available on the World Wide Web. DBpedia allows users to semantically query relationships and properties of Wikipedia resources, including links to other related datasets.

Intent is identified based on relevant keywords/key phrases entered by user, with the help of Dialogflow intent classification model.

This model returns the intent with its score. This score is checked with certain threshold value. If the intent score is below a certain threshold value or the model failed to identify any intent, then the Word2vec algorithm is used. Word2vec is a group of related models that are used to produce word embeddings. These models are shallow, two-layer neural networks that are trained to reconstruct linguistic contexts of words. Word2vec takes as its input a large corpus of text and produces a vector space, typically of several hundred dimensions, with each unique word in the corpus being assigned a corresponding vector in the space. Word vectors are positioned in the vector space such that words that share common context in the corpus are located in close proximity to one another in the space. There are two main training algorithms that are used to learn the embedding from text; they are continuous bag of words (CBOW) and skip grams.

Gensim library for Word2vec and pre-trained word vectors model from genism data has been used.

The similarity between tokens is computed where the computation is represented as sim(d1, d2) where d1 represents the relevant keyword/key phrase entered by user and d2 represents model answers of each question asked by the bot. If the similarity score is below the certain threshold value or the pre-trained model does not contain the relevant keyword/key phrase entered by user, the question is repeated to the user.

Finally, all the relevant intents are collected from the previous computation of similarity and clusters of said relevant intents are formed using heuristics. Based on the name of the clusters, the trait of user is identified.

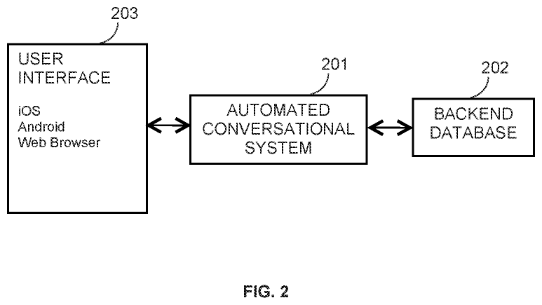

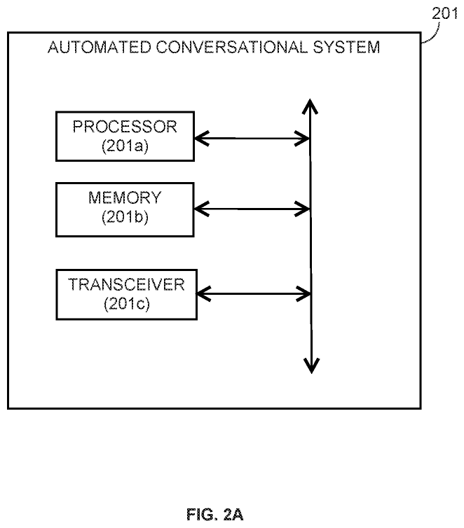

FIG. 2 exemplarily illustrates a block diagram of a passion identification system comprising an automated conversational system 201 in accordance with some of the embodiments of the present invention. Further the passion identification system comprises a user interface. A user uses the user interface 203 to receive queries from the automated conversational system 201 and to respond to said queries. Further, a backend database 202 is coupled to the automated conversational system 201 for storing the conversation history with the user.

FIG. 2A illustrates a functional block diagram of an automated conversational system 201 in accordance with some of the embodiments of the present invention.

The system for identifying a passion of a user comprises at least a processor 201a, a memory 201b and a transceiver 201c, said processor 201a operably coupled to said memory 201b and said transceiver 201c, said memory 201b comprising computer readable instructions to configure the processor 201a for sequentially transmitting a first set of queries to a user wherein said first set of queries comprises an odd number of predetermined plural queries, and wherein each query has two possible answers;

receiving a response comprising textual input from a user for each of said first set of queries, wherein said textual input is classified by an intent classifier to fall into one of said two possible answers;

tallying said responses to each query to determine four basic behavior characteristics of said user;

looking up a table to determine the trait of the user based on said identified four basic behavior characteristics of said user;

sequentially transmitting a second set of queries to a user wherein said second set of queries comprises a plurality of predetermined queries based on said identified trait of said user;

receiving a response comprising textual input from said user for each of said second set of queries; and

classifying said responses by said intent classifier to obtain the passion of said user.

The classification by the intent classifier comprises:

cleaning said received responses using auto spell check and auto correction;

breaking down said cleaned responses into words;

classifying said words to obtain an intent of the user from said responses, wherein classification of said words is carried out by said intent classifier comprising a neural network model trained with a mapping of words to intents.

The classification by said intent classifier further comprises determining a similarity score between words in said responses predetermined model answers of each query to determine intent of said user, wherein a classification confidence provided by the intent classifier for each response is lower than a first predetermined threshold. In case, said similarity score for a response to a query is below a second predetermined threshold value, the query is re-transmitted to the user for a rephrased response.

In the specification the terms “comprise, comprises, comprised and comprising” or any variation thereof and the terms include, includes, included and including” or any variation thereof are considered to be totally interchangeable and they should all be afforded the widest possible interpretation and vice versa.

A person skilled in the art would appreciate that the above invention provides a robust and economical solution to the problems identified in the prior art.

The invention is not limited to the embodiments hereinbefore described but may be varied in both construction and detail.

Further, a person ordinarily skilled in the art will appreciate that the various illustrative logical/functional blocks, modules, circuits, and process steps described in connection with the embodiments disclosed herein may be implemented as electronic hardware, or a combination of hardware and software. To clearly illustrate this interchangeability of hardware and a combination of hardware and software, various illustrative components, blocks, modules, circuits, and steps have been described above generally in terms of their functionality. Whether such functionality is implemented as hardware or a combination of hardware and software depends upon the design choice of a person ordinarily skilled in the art. Such skilled artisans may implement the described functionality in varying ways for each particular application, but such obvious design choices should not be interpreted as causing a departure from the scope of the present invention.

The process described in the present disclosure may be implemented using various means. For example, the apparatus described in the present disclosure may be implemented in hardware, firmware, software current disclosure, or any combination thereof. For a hardware implementation, the processing units, or processors(s) or controller(s) may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

For a firmware and/or software implementation, software codes may be stored in a memory and executed by a processor. Memory may be implemented within the processor unit or external to the processor unit. As used herein the term “memory” refers to any type of volatile memory or nonvolatile memory.

1. A method for identifying a passion of a user, comprising:
sequentially transmitting a first set of queries to a user wherein said first set of queries comprises an odd number of predetermined plural queries, and wherein each query has two possible answers;
receiving a response comprising textual input from a user for each of said first set of queries, wherein said textual input is classified by an intent classifier to fall into one of said two possible answers;
tallying said responses to each query to determine four basic behavior characteristics of said user;
looking up a table to determine the trait of the user based on said identified four basic behavior characteristics of said user;
sequentially transmitting a second set of queries to a user wherein said second set of queries comprises a plurality of predetermined queries based on said identified trait of said user;
receiving a response comprising textual input from said user for each of said second set of queries; and
classifying said responses by said intent classifier to obtain the passion of said user.

2. The method of claim 1, wherein classification by an intent classifier comprises:
cleaning said received responses using auto spell check and auto correction;
breaking down said cleaned responses into words;
classifying said words to obtain an intent of the user from said responses, wherein classification of said words is carried out by said intent classifier comprising a neural network model trained with a mapping of words to intents.

3. The method of claim 2, wherein classification by said intent classifier further comprises determining a similarity score between words in said responses predetermined model answers of each query to determine intent of said user, wherein a classification confidence provided by the intent classifier for each response.

4. The method of claim 3, wherein if said similarity score for a response to a query is below a second predetermined threshold value, the query is re-transmitted to the user for a rephrased response.

5. A system for identifying a passion of a user, comprising at least a processor, a memory and a transceiver, said processor operably coupled to said memory and said transceiver, said memory comprising computer readable instructions to configure the processor for:
sequentially transmitting a first set of queries to a user wherein said first set of queries comprises an odd number of predetermined plural queries, and wherein each query has two possible answers;
receiving a response comprising textual input from a user for each of said first set of queries, wherein said textual input is classified by an intent classifier to fall into one of said two possible answers;
tallying said responses to each query to determine four basic behavior characteristics of said user;
looking up a table to determine the trait of the user based on said identified four basic behavior characteristics of said user;
sequentially transmitting a second set of queries to a user wherein said second set of queries comprises a plurality of predetermined queries based on said identified trait of said user;
receiving a response comprising textual input from said user for each of said second set of queries; and
classifying said responses by said intent classifier to obtain the passion of said user.

6. The system of claim 5, wherein classification by an intent classifier comprises:
cleaning said received responses using auto spell check and auto correction;
breaking down said cleaned responses into words;
classifying said words to obtain an intent of the user from said responses, wherein classification of said words is carried out by said intent classifier comprising a neural network model trained with a mapping of words to intents.

7. The method of claim 5, wherein classification by said intent classifier further comprises determining a similarity score between words in said responses predetermined model answers of each query to determine intent of said user,

8. The method of claim 7, wherein if said similarity score for a response to a query is below a second predetermined threshold value, the query is re-transmitted to the user for a rephrased response.

9. A non-transitory computer readable storage medium storing one or more programs, the one or more programs comprising instructions, which when executed by a processor, causes the processor to:
sequentially transmit a first set of queries to a user wherein said first set of queries comprises an odd number of predetermined plural queries, and wherein each query has two possible answers;
receive a response comprising textual input from a user for each of said first set of queries, wherein said textual input is classified by an intent classifier to fall into one of said two possible answers;
tally said responses to each query to determine four basic behavior characteristics of said user;
look up a table to determine the trait of the user based on said identified four basic behavior characteristics of said user;
sequentially transmit a second set of queries to a user wherein said second set of queries comprises a plurality of predetermined queries based on said identified trait of said user;
receive a response comprising textual input from said user for each of said second set of queries; and
classify said responses by said intent classifier to obtain the passion of said user.
